(19) United States
(12) Patent Application Publication
(10) Pub. No.: US 2022/0351566 A1
(43) Pub. Date: Nov. 3, 2022

(54) CURRENCY COUNTING MACHINES

(71) Applicant: SHENZHEN XPECTVISION TECHNOLOGY CO., LTD., Shenzhen (CN)

(72) Inventors: Peiyan CAO, Shenzhen (CN); Yurun LIU, Shenzhen (CN)

(21) Appl. No.: 17/863,598

(22) Filed: Jul. 13, 2022

Related U.S. Application Data
(63) Continuation of application No. PCT/CN2020/076794, filed on Feb. 26, 2020.

(51) Int. Cl. G07D 11/50; G01N 23/083

(52) U.S. Cl. CPC G07D 11/50; G01N 23/083; G07D 2211/00

(57) ABSTRACT

Disclosed herein is a method, comprising: exposing a stack of currency bills to a radiation; detecting radiation particles of the radiation that have penetrated a pre-specified stack portion of the stack; and determining a number M of the currency bills based on the detected radiation particles.

### TECHNICAL FIELD

The disclosure herein relates to currency counting machines.

### BACKGROUND

Conventional currency counting machines may count a stack of currency bills using different methods. One method is to count the currency bills in the stack one bill at a time. Another method is to weigh the entire stack and then determine the number of currency bills in the stack based on the weight of the stack.

### SUMMARY

Disclosed herein is a method, comprising exposing a stack of currency bills to a radiation; detecting radiation particles of the radiation that have penetrated a pre-specified stack portion of the stack; and determining a number M of the currency bills based on the detected radiation particles.

According to an embodiment, the stack is held in a bill container that prevents the stack from moving relative to the bill container in a direction parallel to the currency bills.

According to an embodiment, the bill container is stationary relative to a particle counting detector.

According to an embodiment, the bill container is physically attached to the particle counting detector.

According to an embodiment, the currency bills are of a same denomination.

According to an embodiment, the currency bills are arranged in a same orientation.

According to an embodiment, the radiation comprises X-ray photons, and the radiation particles are X-ray photons.

According to an embodiment, the radiation is a parallel beam perpendicular to the currency bills.

According to an embodiment, the radiation is a cone beam.

According to an embodiment, the radiation has a pre-specified intensity, and exposing the stack of currency bills to the radiation lasts for a pre-specified duration.

According to an embodiment, the pre-specified stack portion and the stack have a same point of symmetry.

According to an embodiment, the pre-specified stack portion has a shape of a rectangular prism.

According to an embodiment, the pre-specified stack portion has a shape of a cylinder.

According to an embodiment, the pre-specified stack portion is the entire stack.

According to an embodiment, said detecting comprises using a particle counting detector to receive the radiation particles.

According to an embodiment, the particle counting detector is a particle counting detector configured to count a number of photons incident on each sensing element of the particle counting detector.

According to an embodiment, the particle counting detector is configured to count a number of photons incident on a group of sensing elements of the particle counting detector.

According to an embodiment, said determining the number M comprises determining a number N of the radiation particles; and determining M based on N.

According to an embodiment, said determining M based on N comprises searching a lookup table for a best match using a lookup number Ng related to N.

According to an embodiment, Ng=N.

According to an embodiment, Ng=N/Ns, and Ns is a number of sensing elements of a particle counting detector, wherein the sensing elements are in a shadow of the pre-specified stack portion with respect to the radiation.

According to an embodiment, said determining the number M comprises: determining a number N of the radiation particles; determining an adjusted number N′, wherein N′=N*R/Nr, wherein R is a non-zero number, and Nr is a number of radiation particles of the radiation that propagate through a pre-specified reference space area, wherein each point of the pre-specified reference space area is exposed to the radiation, wherein no point of the pre-specified reference space area is in a shadow of the stack with respect to the radiation, and wherein no point of the stack is in a shadow of the pre-specified reference space area with respect to the radiation; and determining M based on N′.

According to an embodiment, said determining M based on N′ comprises searching a lookup table for a best match using a lookup number Ng′ related to N′.

According to an embodiment, Ng′=N′.

According to an embodiment, Ng′=N′/Ns, and Ns is a number of sensing elements of a particle counting detector, wherein the sensing elements are in a shadow of the pre-specified stack portion with respect to the radiation.

According to an embodiment, the method further comprises displaying the determined number M on a display screen.

### BRIEF DESCRIPTION OF FIGURES

FIG. 1A and FIG. 18 schematically show a counting machine, according to an embodiment.

FIG. 2 shows a lookup table, according to an embodiment.

FIG. 3 shows a flow chart summarizing and generalizing an operation of the counting machine, according to an embodiment.

FIG. 4 shows another lookup table, according to an embodiment.

### DETAILED DESCRIPTION

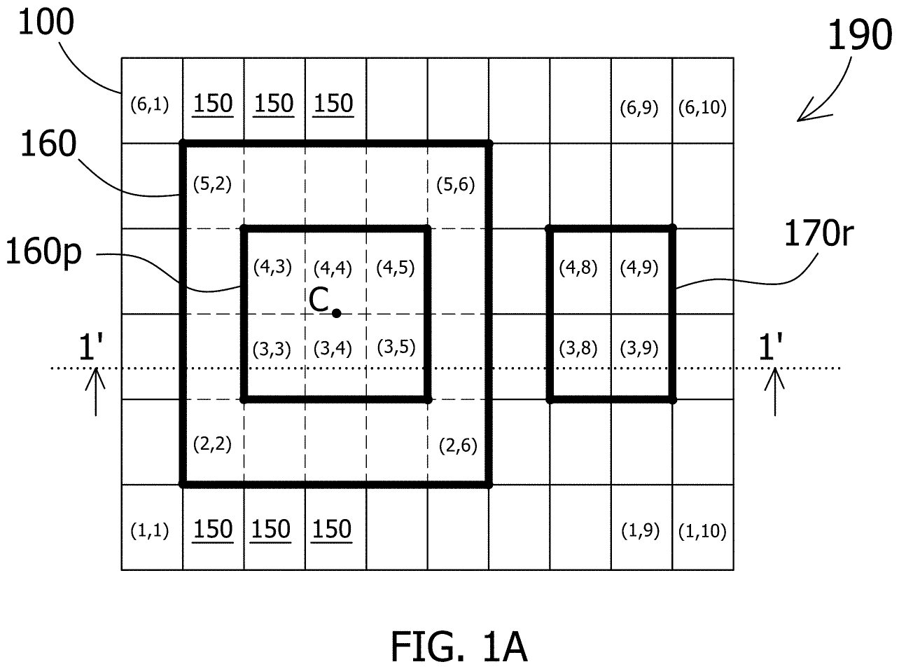

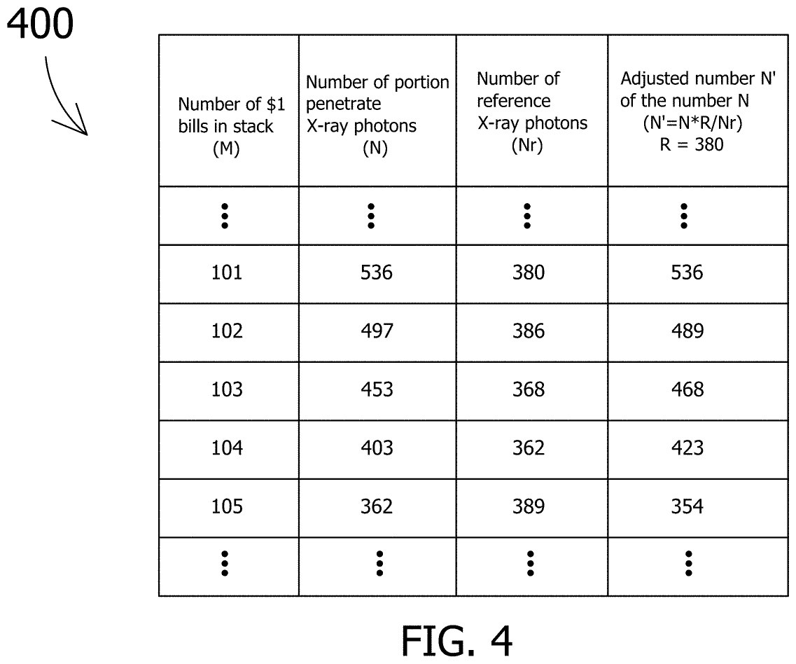

FIG. 1A and FIG. 1B schematically show a counting machine 190, according to an embodiment. Specifically, FIG. 1A schematically shows a top view of the counting machine 190. FIG. 18 shows a cross-sectional view of the counting machine 190 of FIG. 1A along a line 1′-1′.

In an embodiment, the counting machine 190 may comprise a particle counting detector 100, a bill container 160, and an X-ray source 180. For simplicity, the X-ray source 180 is not shown in FIG. 1.

In an embodiment, the particle counting detector 100 may comprise multiple sensing elements 150 (also called pixels 150). For example, the particle counting detector 100 may comprise 60 sensing elements 150 arranged in 6 rows and 10 columns as shown in FIG. 1. In an embodiment, each sensing element 150 may be configured to generate an electrical signal when the sensing element 150 receives a photon from the X-ray source 180. Each sensing element 150 may be individually referred to by its row and column. For instance, the bottom left sensing element 150 (FIG. 1) may be referred to as the sensing element 150(1,1), whereas the top right sensing element 150 may be referred to as the sensing element 150(6,10).

In an embodiment, the particle counting detector 100 may be configured to count (i.e., determine) the number of photons (e.g., X-ray photons from the X-ray source 180) incident on each sensing element 150 of the particle counting detector 100. In an embodiment, the particle counting detector 100 may be configured to count (i.e., determine) the number of photons incident on a group of sensing elements 150 of the particle counting detector 100.

In an embodiment, the X-ray source 180 may be configured to generate X-rays (e.g., X-ray 182) towards the particle counting detector 100. In an embodiment, the X-ray source 180 may be stationary relative to the particle counting detector 100.

In an embodiment, the bill container 160 may be positioned between the particle counting detector 100 and the X-ray source 180. The position of the bill container 160 may be stationary relative to the particle counting detector 100. In an embodiment, the bill container 160 may be physically attached to the particle counting detector 100. In an embodiment, a stack 170 of currency bills 172 may be held in the bill container 160 which prevents the stack of currency bills from moving relative to the bill container 160 in a direction parallel to the currency bills.

In an embodiment, a container space 160p in the bill container 160 may be specified, and only the stack portion 170p of the stack 170 in the container space 160p may be of interest. For example, the container space 160p may be specified to be the space that overshadows the 6 sensing elements 150(3,3), 150(3,4), 150(3,5), 150(4,3), 150(4,4) and 150(4,5) with respect to an X-ray from the X-ray source 180 for illustration. These 6 sensing elements 150 may be referred to as the portion shadow sensing elements 150.

In an embodiment, the container space 160p may be specified such that the resulting stack portion 170p and the stack 170 have the same point of symmetry (point C in FIG. 1A and FIG. 1B). In an embodiment, the container space 160p may be specified such that the resulting stack portion 170p may have the shape of a rectangular prism which has the shape of a rectangle in top view) as shown in FIG. 1A and FIG. 113. Alternatively, the container space 160p may be specified such that the resulting stack portion 170p may have the shape of a cylinder (which has the shape of a circle in top view). Other shapes of the stack portion 170p may be possible.

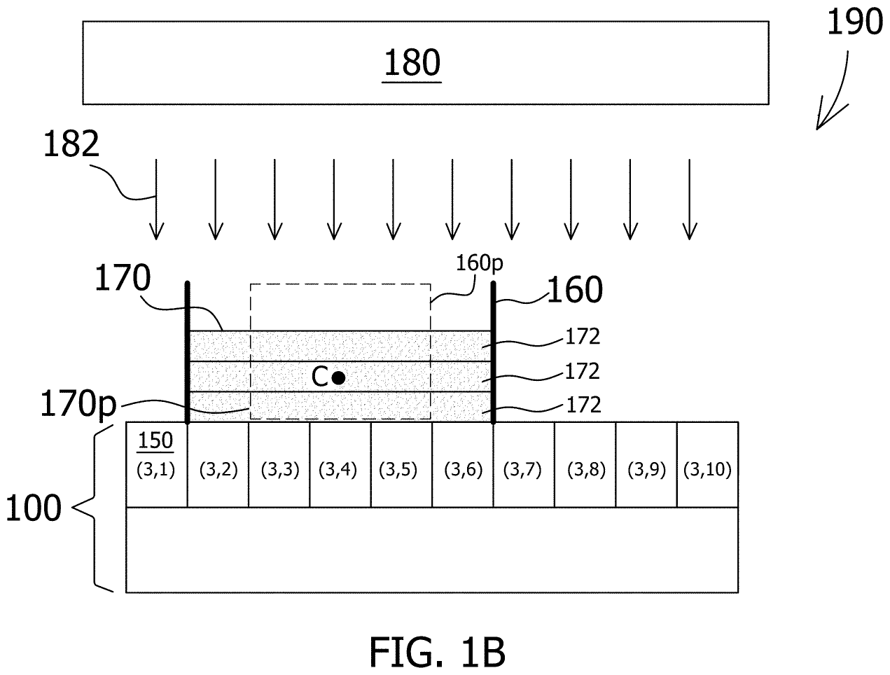

Assume that the counting machine 190 is to be used for counting US $1 bills (i.e., U.S. one-dollar bills). In an embodiment, with reference to FIG. 1A and FIG. 1B, before the counting machine 190 may be used for counting $1 bills, the counting machine 190 (or another counting machine similar to the counting machine 190) may be used to create a lookup table 200 (FIG. 2). The lookup table 200 may have any number of entries, but only 5 entries are shown for illustration.

Specifically, column #1 (left column) of the lookup table 200 may be the number M of $1 bills being counted by the counting machine 190. Column #2 (right column) of the lookup table 200 may be the number N of portion penetrate X-ray photons (which are X-ray photons from the X-ray source 180 that have penetrated the stack portion of the stack of $1 bills in the bill container 160). The values in column #2 may depend on the intensity of the incident X-ray and the duration of exposure of the stack portion to the incident X-ray. Column #2 may contain ranges instead of specific values.

In an embodiment, for completing the 103-bill entry (the entry with M=103) of the lookup table 200, a first stack of 103 $1 bills may be put in the empty bill container 160. Then, a first X-ray may be sent by the X-ray source 180 towards the first stack and the particle counting detector 100. In an embodiment, the first X-ray may be a cone beam or a parallel beam perpendicular to the $1 bills. In an embodiment, the first X-ray may be at a first intensity level and may last for a first duration. In other words, the first X-ray may have the first intensity, and exposing the first stack of bills to the first X-ray may last for the first duration.

As a result of the first X-ray, assume the particle counting detector 100 determines that there are 302 X-ray photons incident on the 6 portion shadow sensing elements 150. This means that there are N=302 portion penetrate X-ray photons. As a result, N=302 may be entered into column #2 of the 103-bill entry (i.e., the entry with M =103) of the lookup table 200 as shown in FIG. 2.

In an embodiment, similarly, for completing the 101-bill entry (the entry with M=101) of the lookup table 200, a second stack of 101 $1 bill may be put in the empty bill container 160. Then, a second X-ray similar to the first X-ray (e.g., the second X-ray may be at the first intensity level and may last for the first duration) may be sent by the X-ray source 180 towards the second stack and the particle counting detector 100. The words “first”, “second”, and other ordinal numerals in this disclosure are used for easy reference and do not imply any chronological order. For example, it is not necessarily that the second X-ray is sent after the first X-ray is sent.

As a result of the second X-ray, assume the particle counting detector 100 determines that there are 357 X-ray photons incident on the 6 portion shadow sensing elements 150. This means that there are N=357 portion penetrate X-ray photons. As a result, N=357 may be entered into column #2 of the 101-bill entry (i.e., the entry with M =101) of the lookup table 200 as shown in FIG. 2.

In an embodiment, the remaining entries of the lookup table 200 may be completed in a similar manner. In general, the lookup table 200 may have any number of entries. If the counting machine 190 is to count at most P $1 bills at a time, then the lookup table 200 needs to have at least P entries, wherein P is a positive integer.

In an embodiment, after the lookup table 200 is completed, a counting operation of the counting machine 190 using the lookup table 200 may be as follows. A third stack of M $1 bills may be put in the empty bill container 160. Then, a third X-ray similar to the first X-ray (e.g., the third X-ray may be at the first intensity level and may last for the first duration) may be sent by the X-ray source 180 towards the third stack and the particle counting detector 100.

As a result of the third X-ray, assume the particle counting detector 100 determines that there are 301 X-ray photons incident on the 6 portion shadow sensing elements 150. This means that there are N=301 portion penetrate X-ray photons.

Next, in an embodiment, a search of the lookup table 200 for the best match using N=301 may be performed thereby returning a value M=103 (because the entry with M=103 has N=302 which is closest to 301). As a result, the counting machine 190 may determine that there are 103 $1 bills in the third stack. In an embodiment, the counting machine 190 may be configured to display number 103 on a display screen (not shown) to indicate to a user that there are 103 $1 bills in the bill container 160.

As another example of the counting operation of the counting machine 190 using the lookup table 200, a fourth stack of M $1 bills may be put in the empty bill container 160. Then, a fourth X-ray similar to the first X-ray (e.g., the fourth X-ray may be at the first intensity level and may last for the first duration) may be sent by the X-ray source 180 towards the fourth stack and the particle counting detector 100.

As a result of the fourth X-ray, assume the particle counting detector 100 determines that there are 245 X-ray photons incident on the 6 portion shadow sensing elements 150. This means that there are N=245 portion penetrate X-ray photons.

Next, in an embodiment, a search of the lookup table 200 for the best match using N=245 may be performed thereby returning a value M=105 (because the entry with M=105 has N=241 which is closest to 245). As a result, the counting machine 190 may determine that there are 105 $1 bills in the fourth stack. Then, the counting machine 190 may display number 105 on the display screen to indicate to the user that there are 105 $1 bills in the bill container 160.

In an embodiment, the container space 160p may be specified to be the entire bill container 160. In this case, the stack portion 170p is the entire stack 170. Assume that the bill container 160 overshadows the 20 sensing elements 150(2,2); 150(2,3); . . . ; and 150(5,6) with respect to an X-ray from the X-ray source 180 as shown in FIG. 1. As a result, in this case, these 20 sensing elements 150 are portion shadow sensing elements. In this case, another lookup table needs to be created and used with the column #2 of this lookup table being the number of the X-ray photons that have penetrated the stack 170. In an embodiment, the values of number N in column #2 of this lookup table may be determined by using the particle counting detector 100 to count the X-ray photons incident on the 20 portion shadow sensing elements 150.

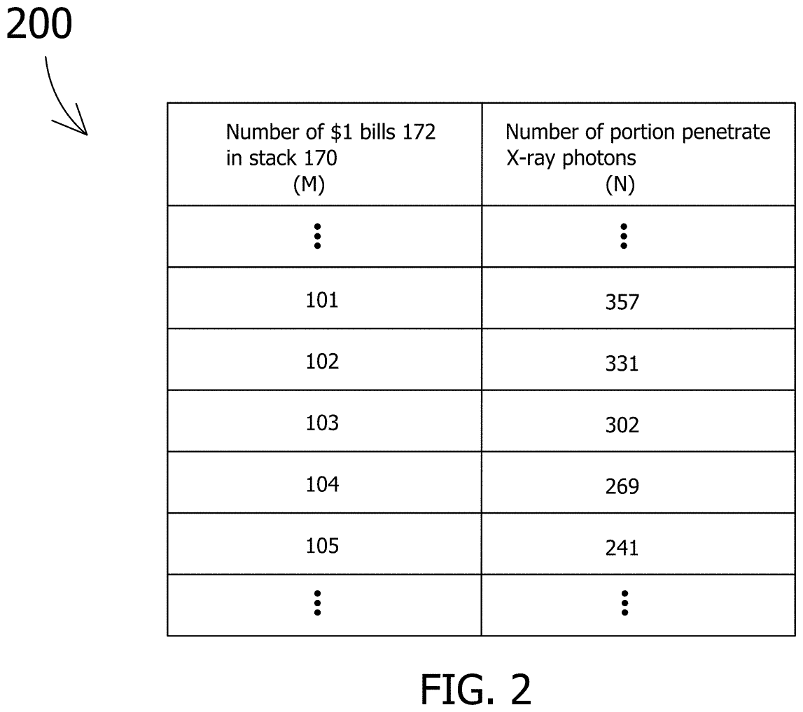

FIG. 3 shows a flow chart 300 summarizing and generalizing the operation of the counting machine 190 as described above. In step 310, a stack of currency bills may be exposed to a radiation. The currency bills may be of the same denomination (e.g., all are $1 bills). The radiation may have a pre-specified intensity (e.g., the first intensity) and exposing the stack of currency bills to the radiation may last for a pre-specified duration (e.g., the first duration). The radiation may be an X-ray generated by a detector (e.g., the X-ray 182 generated by the particle counting detector 100 in FIG. 1).

In step 320, radiation particles of the radiation that have penetrated a pre-specified stack portion of the stack may be detected. This may be done by using the particle counting detector 100 to detect the portion penetrate radiation particles. The stack portion is pre-specified because the stack portion is defined to be in the container space 160p which is pre-specified as described above.

In step 330, a number M of the currency bills of the stack may be determined based on the detected radiation particles. In an embodiment, this may be done by first using the particle counting detector 100 to determine a number N of the radiation particles by counting the radiation particles (e.g., X-ray photons) incident on the sensing elements 150 in the shadow of the stack portion with respect to the radiation, and then searching a lookup table for a best match using the number N thereby returning a value of M.

In the embodiments described above, the source 180 is an X-ray source, and the particle counting detector 100 is a photon counting detector. In general, the source 180 may be a radiation source that may emit radiation particles such as X-rays and gamma rays; and the particle counting detector 100 may be a particle counting detector that may count the number of particles such as X-ray and gamma ray photons incident on the particle counting detector 100.

In the embodiments described above, the particle counting detector 100 comprises 60 sensing elements 150 arranged in 6 rows and 10 columns for illustration. In general, the particle counting detector 100 may comprise any number of sensing elements 150 arranged in any way.

In the embodiments described above, with reference to FIG. 1A and FIG. 1B, the stack portion and the stack are both symmetrical and have the same point of symmetry (point C). In general, the stack portion may have any shape (not necessarily symmetrical). In this general case, in an embodiment, the $1 bills may be arranged in the same orientation in the stack (i.e., the $1 bills may be arranged such that their patterns such as the portrait of President George Washington superimpose on each other or, in other words, align with each other).

In the embodiments described above, the stack comprises $1 bills. In general, all the currency bills in the stack may be of any denomination and of any country or region. For example, all the currency bills of the stack may be 10£ bills of Great Britain. In this example, a lookup table created for 10£ denomination may be created and then used to determine the number M of 10£ bills in the stack.

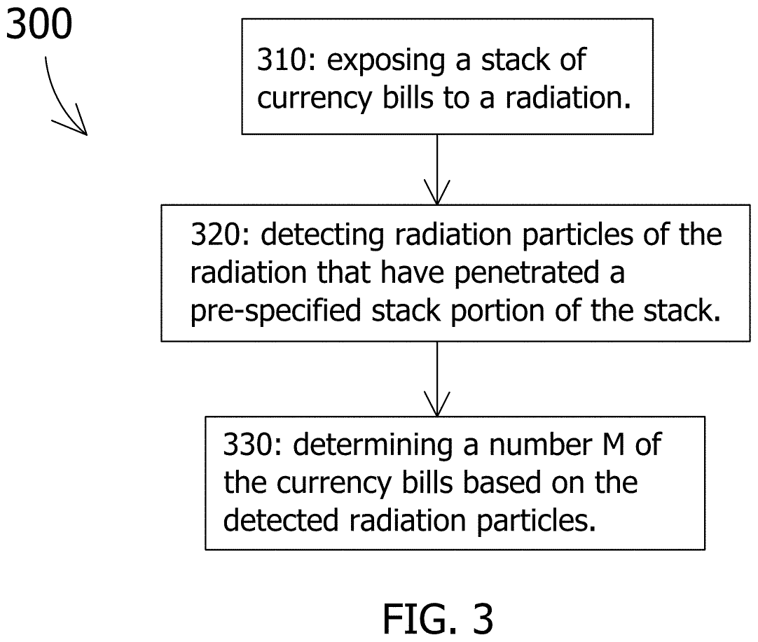

In the embodiments described above, the number N of the portion penetrate X-ray photons (that have penetrated the stack portion) is used not only in creating a lookup table (e.g., the lookup table 200 of FIG. 2) but also in searching that lookup table for the best match thereby returning a number M of the currency bills in the bill container 160. In an alternative embodiment, an adjusted number N′ of the number N may be used not only in creating a lookup table (e.g., the lookup table 400 of FIG. 4) but also in searching that lookup table for the best match thereby returning a number M of the currency bills in the bill container 160. In general, the number of entries of the lookup table 400 may be any positive integer.

In an embodiment, the creation of the lookup table 400 (FIG. 4) may be as follows. In an embodiment, for completing the 101-bill entry (the entry with M=101) of the lookup table 400, a fifth stack of 101 $1 bills may be put in the empty bill container 160. Then, a fifth X-ray being at a second intensity level and lasting for a second duration may be sent by the X-ray source 180 towards the fifth stack and the particle counting detector 100.

As a result of the fifth X-ray, assume the particle counting detector 100 determines that there are 536 X-ray photons incident on the 6 portion shadow sensing elements 150. This means that there are N=536 portion penetrate X-ray photons. As a result, N=536 may be entered into column #2 of the 101-bill entry (i.e., the entry with M=101) of the lookup table 400 as shown in FIG. 4.

In an embodiment, a reference space area may be specified (i.e., chosen). In an embodiment, a reference space area may be defined as an area in space such that (A) each point of the area is exposed to a radiation from the source 180, (B) no point of the area is in a shadow of the bill container 160 (or the stack of currency bills therein) with respect to a radiation from the source 180, and (C) no point of the bill container 160 (or the stack of currency bills therein) is in a shadow of the area with respect to a radiation from the source 180. For example, a radiation receiving area of the particle counting detector 100 outside the bill container 160 may be chosen to be a reference space area. Specifically, with reference to FIG. 1, the radiation receiving area including 4 sensing elements 150(3,8), 150(3,9), 150(4,8), and 150(4,9) may be chosen to be a reference space area (hereafter referred to as the reference space area 170r). These 4 sensing elements 150 in the reference space area 170r may be referred to as the 4 reference sensing elements 150.

Also as a result of the fifth X-ray, assume the particle counting detector 100 determines that there are 380 X-ray photons of the fifth X-ray that propagate through the reference space area 170r and hit the 4 reference sensing elements 150. The X-ray photons incident on these 4 reference sensing elements 150 may be referred to as the reference X-ray photons. Because there are Nr=380 reference X-ray photons, the value 380 may be entered into column #3 of the 101-bill entry of the lookup table 400 as shown in FIG. 4.

In an embodiment, the adjusted number N′ of the number N may be determined using the formula: N′=N*R/Nr, wherein N is the number of portion penetrate X-ray photons, Nr is the number of reference X-ray photons, and R may be a non-zero number. For simplicity, in an embodiment, R may be chosen to be Nr of the entry with M=101, hence R=Nr=380. As a result, N′=536*380/380=536. This value of N′ (i.e., 536) may be entered into column #4 of the 101-bill entry of the lookup table 400 as shown in FIG. 4.

In an embodiment, for completing the 102-bill entry (the entry with M=102) of the lookup table 400, a sixth stack of 102 $1 bills may be put in the empty bill container 160. Then, a sixth X-ray similar to the fifth X-ray (e.g., the sixth X-ray may be at the second intensity level and may last for the second duration) may be sent by the X-ray source 180 towards the sixth stack and the particle counting detector 100.

As a result of the sixth X-ray, assume the particle counting detector 100 determines that there are 497 X-ray photons incident on the 6 portion shadow sensing elements 150. This means that there are N=497 portion penetrate X-ray photons. As a result, N=497 may be entered into column #2 of the 102-bill entry (i.e., the entry with M=102) of the lookup table 400 as shown in FIG. 4.

Also as a result of the sixth X-ray, assume the particle counting detector 100 determines that there are 386 X-ray photons of the sixth X-ray incident on the 4 reference sensing elements 150(3,8), 150(3,9), 150(4,8), and 150(4,9). This means that Nr=386. As a result, the value 386 may be entered into column #3 of the 102-bill entry of the lookup table 400 as shown in FIG. 4. As a result, N′=N*R/Nr=497*380/386=489. This value of N′ (i.e., 489) may be entered into column #4 of the 102-bill entry of the lookup table 400 as shown in FIG. 4. In an embodiment, the remaining entries of the lookup table 400 may be completed in a similar manner.

In an embodiment, after the lookup table 400 is created, a counting operation of the counting machine 190 using the lookup table 400 may be as follows. A seventh stack of M $1 bills may be put in the empty bill container 160. Then, a seventh X-ray similar to the fifth X-ray (e.g., the seventh X-ray may be at the second intensity level and may last for the second duration) may be sent by the X-ray source 180 towards the seventh stack and the particle counting detector 100.

As a result of the seventh X-ray, assume the particle counting detector 100 determines that there are 455 X-ray photons of the seventh X-ray incident on the 6 portion shadow sensing elements 150. This means that there are N=455 portion penetrate X-ray photons. Assume the particle counting detector 100 also determines that there are Nr=370 reference X-ray photons incident on the 4 reference sensing elements 150 in the reference space area 170r. As a result, the particle counting detector 100 may determine that N′=N*R/Nr=455*380/370 =467.

Next, in an embodiment, a search of the lookup table 400 for the best match using N′=467 may be performed thereby returning a value M=103 (because the entry with M=103 has N′=468 which is closest to 467). As a result, the counting machine 190 may determine that there are 103 $1 bills in the seventh stack. In an embodiment, the counting machine 190 may be configured to display number 103 on the display screen to indicate to the user that there are 103 $1 bills in the bill container 160.

In the embodiments described above, the stack 170 overshadows 20 sensing elements 150. The stack portion 170p overshadows 6 sensing elements 150. The reference space area 170r occupies 4 sensing elements 150. These 3 values (i.e., 20, 6, and 4) are used for illustration only.

In the embodiments described above, with reference to FIG. 2, the number N of the portion penetrate X-ray photons (that have penetrated the stack portion 170p) is used not only in creating a lookup table (e.g., the lookup table 200 of FIG. 2) but also in searching that lookup table for the best match thereby returning a number M of the currency bills 172 in the bill container 160. In general, a lookup number Ng related to the number N may be used not only in creating a lookup table but also in searching that lookup table for the best match thereby returning a number M of the currency bills 172 in the bill container 160. The case Ng=N is already described above. Alternatively, Ng may be determined using formula Ng=N/Ns, wherein Ns is the number of portion shadow sensing elements 150 (e.g., Ns=6 in the embodiments described above).

In the embodiments described above, with reference to FIG. 4, the adjusted number N′ is used not only in creating a lookup table (e.g., the lookup table 400 of FIG. 4) but also in searching that lookup table for the best match thereby returning a number M of the currency bills 172 in the bill container 160. In general, a lookup number Ng′ related to the number N′ may be used not only in creating a lookup table but also in searching that lookup table for the best match thereby returning a number M of the currency bills 172 in the bill container 160. The case Ng′=N′ is already described above. Alternatively, Ng′ may be determined using formula Ng′=N′/Ns, wherein Ns is the number of portion shadow sensing elements 150 (e.g., Ns=6 in the embodiments described above).

While various aspects and embodiments have been disclosed herein, other aspects and embodiments will be apparent to those skilled in the art. The various aspects and embodiments disclosed herein are for purposes of illustration and are not intended to be limiting, with the true scope and spirit being indicated by the following claims.

1. A method, comprising:
exposing a stack of currency bills to a radiation;
detecting radiation particles of the radiation that have penetrated a pre-specified stack portion of the stack; and
determining a number M of the currency bills based on the detected radiation particles;
wherein said determining the number M comprises:
determining a number N of the radiation particles;
determining an adjusted number N′, wherein N′=N*R/Nr, wherein R is a non-zero number, and Nr is a number of radiation particles of the radiation that propagate through a pre-specified reference space area, wherein each point of the pre-specified reference space area is exposed to the radiation, wherein no point of the pre-specified reference space area is in a shadow of the stack with respect to the radiation, and wherein no point of the stack is in a shadow of the pre-specified reference space area with respect to the radiation; and
determining M based on N′.

2. The method of claim 1, wherein the stack is held in a bill container that prevents the stack from moving relative to the bill container in a direction parallel to the currency bills.

3. The method of claim 2, wherein the bill container is stationary relative to a particle counting detector.

4. The method of claim 3, wherein the bill container is physically attached to the particle counting detector.

5. The method of claim 1, wherein the currency bills are of a same denomination.

6. The method of claim 1, wherein the currency bills are arranged in a same orientation.

7. The method of claim 1,
wherein the radiation comprises X-ray photons, and
wherein the radiation particles are X-ray photons.

8. The method of claim 1, wherein the radiation is a parallel beam perpendicular to the currency bills.

9. The method of claim 1, wherein the radiation is a cone beam.

10. The method of claim 1, wherein the radiation has a pre-specified intensity, and wherein exposing the stack of currency bills to the radiation lasts for a pre-specified duration.

11. The method of claim 1, wherein the pre-specified stack portion and the stack have a same point of symmetry.

12. The method of claim 11, wherein the pre-specified stack portion has a shape of a rectangular prism.

13. The method of claim 11, wherein the pre-specified stack portion has a shape of a cylinder.

14. The method of claim 1, wherein the pre-specified stack portion is the entire stack.

15. The method of claim 1, wherein said detecting comprises using a particle counting detector to receive the radiation particles.

16. The method of claim 15, wherein the particle counting detector is a photon counting detector configured to count a number of photons incident on each sensing element of the photon counting detector.

17. The method of claim 16, wherein the photon counting detector is configured to count a number of photons incident on a group of sensing elements of the photon counting detector.

18. The method of claim 1, wherein said determining the number M comprises:
determining a number N of the radiation particles; and
determining M based on N.

19. The method of claim 18, wherein said determining M based on N comprises searching a lookup table for a best match using a lookup number Ng related to N.

20. The method of claim 19, wherein Ng=N.

21. The method of claim 19,
wherein Ng=N/Ns, and
wherein Ns is a number of sensing elements of a particle counting detector, wherein the sensing elements are in a shadow of the pre-specified stack portion with respect to the radiation.

22. (canceled)

23. The method of claim 1, wherein said determining M based on N′ comprises searching a lookup table for a best match using a lookup number Ng′ related to N′.

24. The method of claim 23, wherein Ng′=N′.

25. The method of claim 23,
wherein Ng′=N′/Ns, and
wherein Ns is a number of sensing elements of a particle counting detector, wherein the sensing elements are in a shadow of the pre-specified stack portion with respect to the radiation.

26. The method of claim 1, further comprising displaying the determined number M on a display screen.
